(19) United States
(12) Patent Application Publication
(10) Pub. No.: US 2026/0179616 A1
(43) Pub. Date: Jun. 25, 2026

(54) SPEECH RECOGNITION METHOD AND SPEECH RECOGNITION APPARATUS

(71) Applicant: SHARP KABUSHIKI KAISHA, Sakai City (JP)

(72) Inventors: Eri Aono, Sakai City (JP); Noriko Hata, Sakai City (JP); Tatsuya Nishio, Sakai City (JP)

(21) Appl. No.: 19/407,309

(22) Filed: Dec. 3, 2025

(30) Foreign Application Priority Data
Dec. 19, 2024 (JP) 2024-224310

(51) Int. Cl. G10L 15/22; G10L 25/93

(52) U.S. Cl. CPC G10L 15/22; G10L 25/93

(57) ABSTRACT

A speech recognition method of the disclosure includes a speech data accumulation step of acquiring speech data and accumulating the acquired speech data as accumulated speech data, an utterance determination step of determining whether there is an utterance for the acquired speech data or not, a decision step of deciding whether to end the accumulation of the speech data or continue the accumulation of the speech data based on a result of the determination as to whether there is an utterance or not that is determined in the utterance determination step, and an accumulation time of the accumulated speech data, and a speech recognition step of performing speech recognition based on the accumulated speech data in a case where the accumulation of the speech data has ended and the accumulated speech data exists.

### TECHNICAL FIELD

The disclosure relates to a speech recognition method and a speech recognition apparatus.

### BACKGROUND ART

It is known that in a speech recognition system, an AI model (for example, an HMM-DNN method or the like) that performs speech recognition when performing transcription from speech is used. In such a speech recognition system, an utterance section is detected from speech data, and speech recognition processing is performed for the speech data in the utterance section using the AI model.

### SUMMARY

### Technical Problem

However, in a speech recognition system of the related art, an incorrect transcription result may be output.

The disclosure is made in view of such circumstances, and provides a speech recognition method capable of improving accuracy of transcription (speech recognition accuracy) using an AI model.

### Solution to Problem

The disclosure provides a speech recognition method including a speech data accumulation step of acquiring speech data and accumulating (recording) the acquired speech data as accumulated speech data, an utterance determination step of determining whether there is an utterance for the acquired speech data or not, a decision step of deciding whether to end the accumulation of the speech data or continue the accumulation of the speech data based on a result of the determination as to whether there is the utterance or not that is determined in the utterance determination step, and an accumulation time of the accumulated speech data, and a speech recognition step of performing speech recognition based on the accumulated speech data in a case where the accumulation of the speech data has ended and the accumulated speech data exists.

Additionally, the disclosure provides a speech recognition apparatus including a controller including a storage, wherein the controller is provided to accumulate acquired speech data in the storage as accumulated speech data, is provided to decide whether to end the accumulation of the speech data or continue the accumulation of the speech data based on a result of determination as to whether there is an utterance regarding the acquired speech data or not and an accumulation time of the accumulated speech data, and is provided to perform speech recognition based on the accumulated speech data in a case where the accumulation of the speech data has ended and the accumulated speech data exists.

### Advantageous Effects of Disclosure

According to the disclosure, since it is determined whether to continue accumulation (recording) of speech data acquired based on a result of determination as to whether there is an utterance or not and an accumulation time of accumulated speech data or not, it is possible to perform speech recognition for speech data having a length appropriate for an AI model. Therefore, accuracy of transcription using the AI model can be improved.

### BRIEF DESCRIPTION OF THE DRAWINGS

FIG. 1 is a flowchart of a character recognition method of an embodiment of the disclosure.

FIG. 2 is the flowchart of the character recognition method of the embodiment of the disclosure.

FIG. 3 is a block diagram illustrating the formation of a character recognition apparatus of the embodiment of the disclosure.

FIG. 4 is an example of a speech waveform in a case where there is an utterance.

### DESCRIPTION OF EMBODIMENTS

A speech recognition method of the disclosure includes a speech data accumulation step of acquiring speech data and accumulating the acquired speech data as accumulated speech data, an utterance determination step of determining whether there is an utterance for the acquired speech data or not, a decision step of deciding whether to end the accumulation of the speech data or continue the accumulation of the speech data based on a result of the determination as to whether there is the utterance or not that is determined in the utterance determination step, and an accumulation time of the accumulated speech data, and a speech recognition step of performing speech recognition based on the accumulated speech data in a case where the accumulation of the speech data has ended and the accumulated speech data exists.

In the decision step, in a case where it is determined that there is no utterance in the utterance determination step, a duration of a state without utterance is longer than a first threshold value, and the accumulation time of the accumulated speech data is longer than a second threshold value, the accumulation of the speech data is preferably ended. In the decision step, in a case where it is determined that there is no utterance in the utterance determination step, the duration of the state without utterance is longer than the first threshold value, and the accumulation time of the accumulated speech data is shorter than the second threshold value, the accumulation of the speech data is preferably continued.

In the decision step, in a case where it is determined that there is no utterance in the utterance determination step, and the duration of the state without utterance is shorter than the first threshold value, whether the accumulated speech data accumulated before a predetermined time point exists or not is preferably determined, and in a case where it is determined that the accumulated speech data accumulated before the predetermined time point exists, the accumulation of the speech data is preferably continued.

In the decision step, in a case where it is determined that there is no utterance in the utterance determination step, and the duration of the state without utterance is shorter than the first threshold value, whether the accumulated speech data accumulated before the predetermined time point exists or not is preferably determined, and in a case where it is determined that the accumulated speech data accumulated before the predetermined time point does not exist, the accumulation of the speech data is preferably ended. In the decision step, in a case where the accumulated speech data accumulated after the predetermined time point exists, the accumulated speech data accumulated after the predetermined time point is preferably deleted.

In the decision step, in a case where it is determined that there is an utterance in the utterance determination step and a duration of a state with the utterance is longer than a third threshold value, the accumulation of the speech data is preferably ended.

In the decision step, in a case where it is determined that there is an utterance in the utterance determination step and the duration of the state with the utterance is shorter than the third threshold value, the accumulation of the speech data is preferably continued. A cycle including the speech data accumulation step, the utterance determination step, and the decision step is repeatedly performed.

An embodiment of the disclosure will be described below with reference to the drawings. Configurations illustrated in the drawings and presented in the following description are examples, and the scope of the disclosure is not limited to the configurations illustrated in the drawings or presented in the following description.

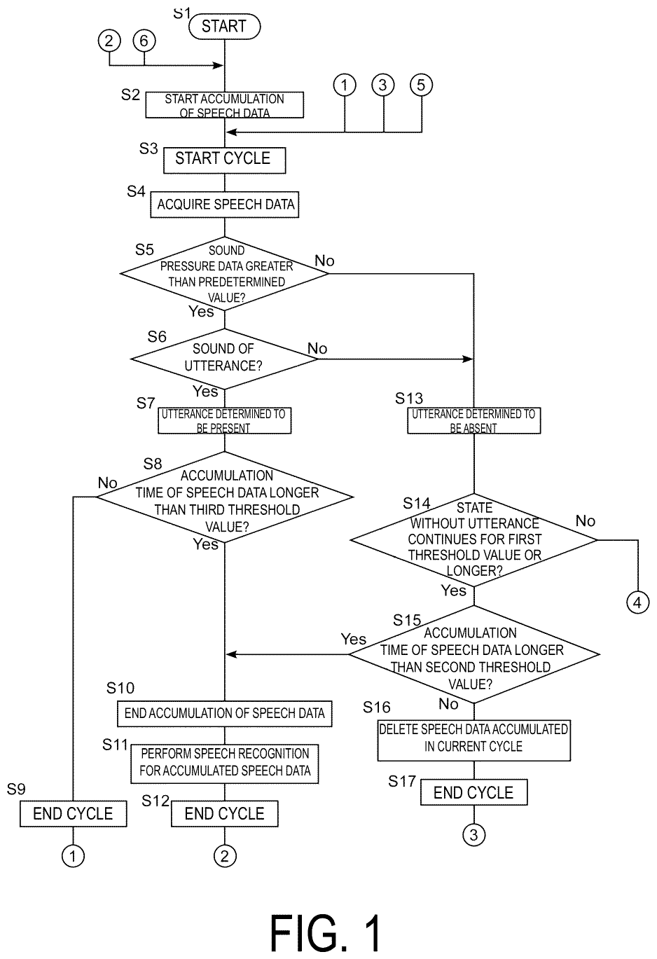

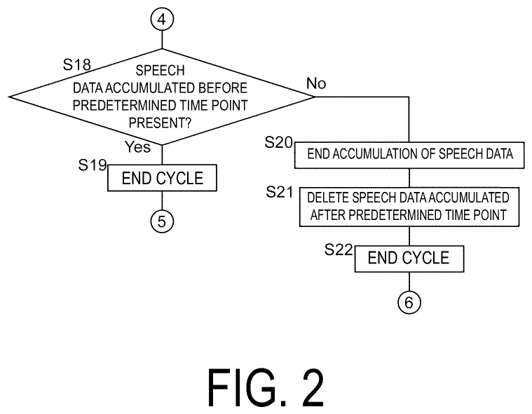

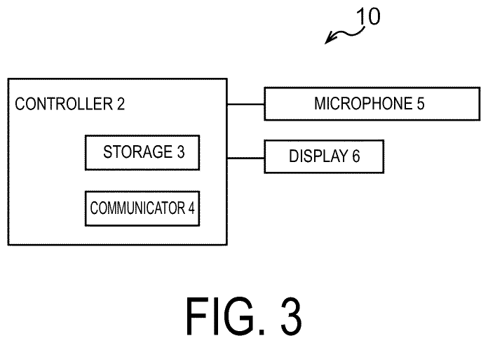

FIGS. 1 and 2 are a flowchart of a speech recognition method of the embodiment. FIG. 3 is a block diagram of a speech recognition apparatus capable of implementing the speech recognition method of the embodiment.

The speech recognition method of the embodiment includes the speech data accumulation step of acquiring speech data and accumulating the acquired speech data as accumulated speech data, the utterance determination step of determining whether there is an utterance for the acquired speech data or not, the decision step of deciding whether to end the accumulation of the speech data or continue the accumulation of the speech data based on a result of the determination as to whether there is the utterance or not that is determined in the utterance determination step, and an accumulation time of the accumulated speech data, and the speech recognition step of performing speech recognition based on the accumulated speech data in a case where the accumulation of the speech data has ended and the accumulated speech data exists.

The speech data accumulation step includes, for example, at least one of steps S2 and S4 in the flowchart illustrated in FIGS. 1 and 2.

The utterance determination step includes, for example, at least one of steps S5, S6, S7, and S13 in the flowchart illustrated in FIGS. 1 and 2.

The decision step includes, for example, at least one of steps S8, S10, S14, S15, S18, and S20 in the flowchart illustrated in FIGS. 1 and 2.

The speech recognition step includes, for example, step S11 in the flowchart illustrated in FIGS. 1 and 2.

The speech recognition method of the embodiment can be implemented by, for example, a speech recognition apparatus 10 as illustrated in FIG. 3.

The speech recognition apparatus 10 of the embodiment includes a controller 2 including a storage 3, wherein the controller 2 is provided to accumulate acquired speech data in the storage 3 as accumulated speech data, is provided to decide whether to end the accumulation of the speech data or continue the accumulation of the speech data based on a result of determination as to whether there is an utterance regarding the acquired speech data or not and an accumulation time of the accumulated speech data, and is provided to perform speech recognition based on the accumulated speech data in a case where the accumulation of the speech data has ended and the accumulated speech data exists. The speech recognition apparatus 10 may be included in a speech recognition-based automatic minutes system, a speech recognition-based conversation recording system, or a speech-to-text system. The controller 2 can include a processor, the storage 3, a communicator 4, and the like. The processor can include, for example, at least one of a CPU, an MPU, a GPU, and the like.

The storage 3 is a RAM, a storage, or the like. The communicator 4 is a component provided so as to be connected to the Internet, a local area network, or the like. The controller 2 can be connected to a microphone 5 from which a speech signal output from the microphone 5 can be input.

Further, the controller 2 can be connected to a user interface such as a display 6 from which a recognition result of the speech recognition method of the embodiment can be output to the user interface.

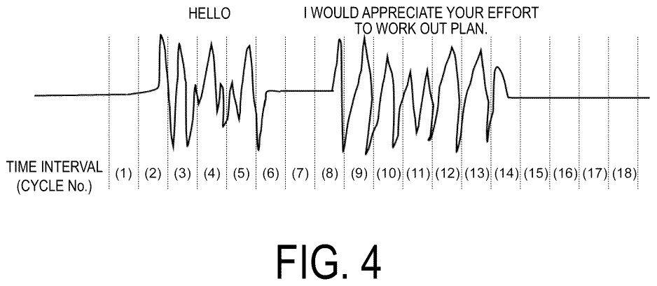

FIG. 4 is an example of a speech waveform in a case where there is an utterance. The speech waveform is a change in the speech signal (for example, an output signal of the microphone 5) displayed on a time axis. Further, the speech data is time-series data of the speech signal. In FIG. 4, dotted lines indicate boundaries of speech data acquired by the controller 2 in step S4, and numbers (or cycle numbers) of time intervals about the speech data of the respective time intervals are also illustrated. The number of time intervals and the cycle number are the same.

The speech recognition method of the embodiment will be described mainly using the flowchart illustrated in FIGS. 1 and 2 about the example illustrated in FIG. 4 and a block diagram of the speech recognition apparatus 10 illustrated in FIG. 3.

When the flow is started (step S1), the controller 2 first starts accumulation (recording) of speech data (step S2). For example, the controller 2 stores speech data to be acquired in subsequent cycles as accumulated speech data in the storage 3 until the accumulation has ended. The accumulation (recording) of the speech data is continuously stored until the accumulation has ended, for example, in steps S10, S20, or the like. The accumulated speech data from the start to the end of the accumulation of the speech data can be regarded as one piece of data.

The controller 2 starts a cycle (1) (see FIG. 4) for a time interval (1) in step S3, and acquires speech data in the time interval (1) in FIG. 4 in step S4. Since the accumulation of the speech data is started, the speech data acquired in step S4 is stored in the storage 3 as the accumulated speech data. When the accumulated speech data is already stored in the storage 3, the controller 2 combines the acquired speech data with the stored accumulated speech data.

The time interval of the speech data acquired by the controller 2 in step S4 is, for example, from 0.01 seconds to 1.0 seconds, and preferably from 0.01 seconds to 0.05 seconds. For example, the controller 2 may directly acquire the speech data output from the microphone. Further, the controller 2 may store a speech signal output from the microphone in the storage 3 and acquire the speech data in the above time interval from the storage 3. Further, the controller 2 may acquire the speech data from the Internet or a local area network via the communicator 4, or may acquire the speech data in the above time interval from the speech data already stored in the storage 3.

In step S5, the controller 2 determines whether a sound pressure of the speech data acquired in step S4 is greater than a predetermined value or not. For example, the controller 2 determines whether the relative magnitude (sound pressure) of the speech signal included in the speech data acquired in step S4 with respect to the magnitude of a speech signal in a time period in which there is almost no change in a speech waveform (a time period without utterance) is greater than a predetermined value or not. The predetermined value is set to determine whether the speech data includes an utterance or not, and may be, for example, set to a minimum sound pressure of an utterance. When determining that the sound pressure of the speech data is less than the predetermined value, the controller 2 proceeds to step S13, and determines that there is no utterance. When determining that the sound pressure of the speech data is greater than the predetermined value, the controller 2 proceeds to step S6.

Since there is almost no change in the speech waveform of the speech data in the time interval (1), the controller 2 determines that there is no utterance in step S13, and proceeds to step S14.

In step S14, the controller 2 determines whether the state without utterance continues for a first threshold value or longer or not. The first threshold value is a threshold value to determine whether the state is a temporary interruption of utterance due to breathing, back-channel, thinking, or the like or not. The first threshold value is, for example, a value from 0.1 seconds to 1.5 seconds.

When the state without utterance continues for the first threshold value or longer, the controller 2 determines that the state is not a temporary interruption of utterance, and proceeds to step S15.

When a duration of the state without utterance is shorter than the first threshold value, the controller 2 determines that there is a possibility of a temporary interruption of utterance, and proceeds to step S18. Since a temporary interruption of the utterance due to breathing, back-channel, thinking, or the like is important information for transcription by the AI model, the controller 2 performs processing such as steps S14 and S18 so that the accumulated speech data includes such a temporary interruption. In addition, since the accumulated speech data includes a temporary interruption, when the speech recognition is performed using the AI model, the speech data for which the speech recognition is performed can be made relatively long, and the speech recognition can be performed in consideration of context or the like. Therefore, it is possible to improve accuracy of transcription of the speech recognition using the AI model.

In the cycle (1), since the state without utterance is short, the processing proceeds to step S18.

In step S18, the controller 2 determines whether there is the accumulated speech data accumulated before a predetermined time point or not. The predetermined time point is, for example, a time point before 0.5 seconds from a time point at which a current cycle starts. Further, the predetermined time point may be the time point at which the current cycle is started or a time point at which a cycle before the current cycle is started. In the cycle (1), since there is no accumulated speech data accumulated up to a previous cycle, the processing proceeds to step S20, to end the accumulation of the speech data. Then, the controller 2 deletes the accumulated speech data accumulated after the predetermined time point in step S21, and ends the cycle (1) in step S22. When the predetermined time point is the time point at which the current cycle is started, the accumulated speech data accumulated in the cycle (1) is deleted.

After the cycle (1) is ended in step S22, the controller 2 returns to step S2 and starts accumulation of speech data. Speech data to be acquired in step S4 that follows is accumulated as accumulated speech data different from the accumulated speech data previously stored in the storage 3. The controller 2 starts a cycle (2) for a time interval (2) in step S3, and acquires speech data in the time interval (2) in FIG. 4 in step S4. The speech data acquired in step S4 is stored in the storage 3 as the accumulated speech data. In step S5, the controller 2 determines whether a sound pressure of the speech data acquired in step S4 is greater than the predetermined value or not. The speech waveform in the time interval (2) in FIG. 4 is greatly changed, and the controller 2 determines that the sound pressure of the speech data acquired in step S4 is greater than the predetermined value, and proceeds to step S6.

In step S6, the controller 2 determines whether a sound of utterance is included in the speech data acquired in step S4 or not. In step S6, the controller 2 can determine whether a sound of utterance is included in the speech data or not by detecting a sound of utterance using Voice Activity Detection (VAD).

The VAD is a process of determining whether a speaker is actually speaking or not from a speech signal. In the VAD, it is possible to determine whether a sound of an utterance is included or not by using a machine learning model. For example, when the VAD is used, the controller 2 can determine that speech data does not include a sound of the utterance speech even in a case where speech is included but the speech is noise such as coughing.

When determining that the speech data does not include utterance data, the controller 2 determines that there is no utterance in step S13 and proceeds to step S14. When determining that the speech data includes utterance data, the controller 2 determines that there is an utterance in step S7, and proceeds to step S8.

The controller 2 determines that a speech waveform in the time interval (2) in FIG. 4 includes an utterance, and proceeds to step S8.

In step S8, the controller 2 determines whether an accumulation time (recording time) of the accumulated speech data stored in the storage 3 is longer than a third threshold value or not. The third threshold value is an upper limit value of the accumulation time of the accumulated speech data. The third threshold value is, for example, a value from 20 seconds to 40 seconds. The third threshold value is longer than the second threshold value. By setting the third threshold value to be relatively long in this manner, when the speech recognition is performed using the AI model, speech data for which the speech recognition is performed can be made relatively long, and it is possible to perform the speech recognition in consideration of context or the like. Therefore, it is possible to improve the accuracy of transcription of the speech recognition using the AI model. Further, even while utterance is continued, when the accumulation time of the accumulated speech data is too long, a time lag occurs from the utterance to the speech recognition, and thus when the accumulation time of the accumulated speech data is longer than the third threshold value, the process proceeds to step S10 even during the utterance, and the controller 2 ends the accumulation of the speech data.

When the accumulation time of the accumulated speech data is shorter than the third threshold value, the processing proceeds to steps S9 and S3, and the controller 2 starts the next cycle while continuing the accumulation of the speech data.

In the cycle (2), since the accumulation time of the accumulated speech data is short, the processing proceeds to steps S9 and S3, and the controller 2 starts a cycle (3) while continuing the accumulation of the speech data.

The controller 2 performs control processing in an order of steps S3, S4, S5, S6, S7, S8, and S9 in each of the cycle (3) for a time interval (3), a cycle (4) for a time interval (4), a cycle (5) for a time interval (5), and a cycle (6) for a time interval (6), as in the cycle (2). The controller 2 acquires speech data in the time interval (3) in the cycle (3), acquires speech data in the time interval (4) in the cycle (4), acquires speech data in the time interval (5) in the cycle (5), and acquires speech data in the time interval (6) in the cycle (6). When each piece of the speech data is acquired, the acquired speech data is combined with the accumulated speech data that is already stored. In this manner, the controller 2 accumulates the accumulated speech data.

After the cycle (6) is ended, the controller 2 starts a cycle (7) for a time interval (7) in step S3, acquires speech data in the time interval (7) in step S4, and combines the acquired speech data with the accumulated speech data that is already stored.

In step S5, the controller 2 determines whether a sound pressure of the speech data acquired in step S4 is greater than the predetermined value or not. Since there is almost no change in the speech waveform of the speech data in the time interval (7) in FIG. 4, the controller 2 determines that there is no utterance in step S13, and proceeds to step S14.

In step S14, the controller 2 determines whether the state without utterance continues for the first threshold value or longer or not. In the cycle (7), the controller 2 determines that the state without utterance is short and may be a temporary interruption of utterance, and proceeds to step S18.

In step S18, the controller 2 determines whether there is the accumulated speech data accumulated before a predetermined time point or not. The predetermined time point is, for example, a time point at which the current cycle starts.

In the cycle (7), since there is the accumulated speech data accumulated up to the previous cycle, the processing proceeds to step S19, and the cycle (7) is ended. In this case, the controller 2 determines that the state without utterance may be a temporary interruption, and returns to step S3 to continue the accumulation of the speech data.

After the cycle (7) is ended in step S19, the controller 2 returns to step S3 while continuing the accumulation of the speech data, starts a cycle (8) for a time interval (8), and in step S4, acquires speech data in the time interval (8) in FIG. 4 and combines the acquired speech data with the accumulated speech data that is already stored.

In step S5, the controller 2 determines whether a sound pressure of the speech data acquired in step S4 is greater than the predetermined value or not. A speech waveform in the time interval (8) in FIG. 4 is greatly changed, and the controller 2 determines that the sound pressure of the speech data acquired in step S4 is greater than the predetermined value, and proceeds to step S6.

In step S6, the controller 2 determines whether a sound of utterance is included in the speech data acquired in step S4 or not. In step S6, the controller 2 can detect a sound of utterance using the Voice Activity Detection (VAD) and determine whether a sound of utterance is included in the speech data or not. Since the speech data includes an utterance as in the speech waveform in the time interval (8) in FIG. 4, the controller 2 determines that there is an utterance in step S7, and proceeds to step S8.

In step S8, the controller 2 determines whether the accumulation time (recording time) of the accumulated speech data stored in the storage 3 is longer than the third threshold value or not.

In the cycle (8), since the accumulation time of the accumulated speech data is short, the processing proceeds to steps S9 and S3, and the controller 2 starts a cycle (9) while continuing the accumulation of the speech data.

Since it is determined that there is no utterance in the cycle (7), but it is determined that there is an utterance in the cycle (8), the time interval (7) can be considered to be a temporary interruption due to breathing, back-channel, thinking, or the like. In the speech recognition method of the embodiment, such a temporary interruption can be included in the accumulated speech data, and the accuracy of transcription using the AI model can be improved.

The controller 2 performs the control processing in an order of steps S3, S4, S5, S6, S7, S8, and S9 in each of the cycle (9) for a time interval (9), a cycle (10) for a time interval (10), a cycle (11) for a time interval (11), a cycle (12) for a time interval (12), a cycle (13) for a time interval (13), and a cycle (14) for a time interval (14), as in the cycle (8). The controller 2 acquires speech data in the time interval (9) in the cycle (9), acquires speech data in the time interval (10) in the cycle (10), acquires speech data in the time interval (11) in the cycle (11), acquires speech data in the time interval (12) in the cycle (12), acquires speech data in the time interval (13) in the cycle (13), and acquires speech data in the time interval (14) in the cycle (14). In each cycle, the controller 2 combines the acquired speech data with the accumulated speech data that is already stored. In this manner, the controller 2 accumulates the accumulated speech data, and then starts a cycle (15).

However, when the controller 2 determines that the accumulation time of the accumulated speech data stored in the storage 3 is longer than the third threshold value in any step S8 of the cycles (9) to (14), the controller 2 determines that the accumulation time of the accumulated speech data reaches the upper limit value and proceeds to step S10.

The controller 2 ends the accumulation of the speech data in step S10, and performs speech recognition processing for the accumulated speech data stored in the storage 3 using the AI model in step S11. When the controller 2 stores the AI model, the controller 2 can perform the speech recognition processing. Further, the controller 2 may transmit the accumulated speech data to a server on the Internet or a local area network via the communicator 4, the speech recognition processing may be performed in the server, and a result thereof may be received via the communicator 4.

Further, the controller 2 may output the result of the speech recognition to a user interface such as the display 6.

Thereafter, the cycle is ended in step S12, and accumulation of next speech data is started in step S2. Speech data to be acquired in step S4 that follows is accumulated as accumulated speech data different from the accumulated speech data previously stored in the storage 3.

Hereinafter, it is assumed that the accumulation time (recording time) of the accumulated speech data does not reach the upper limit value in the cycles (9) to (14), and description will be given.

After the cycle (14) is ended, the controller 2 starts the cycle (15) for a time interval (15) in step S3, acquires speech data in the time interval (15) in step S4, and combines the acquired speech data with the accumulated speech data that is already stored. In step S5, the controller 2 determines whether a sound pressure of the speech data acquired in step S4 is greater than the predetermined value or not. Since there is almost no change in the speech waveform of the speech data in the time interval (15) in FIG. 4, the controller 2 determines that there is no utterance in step S13, and proceeds to step S14.

In step S14, the controller 2 determines whether the state without utterance continues for the first threshold value or longer or not. In the cycle (15), the controller 2 determines that the state without utterance is short and may be a temporary interruption of utterance, and proceeds to step S18.

In step S18, the controller 2 determines whether there is the accumulated speech data accumulated before a predetermined time point or not. The predetermined time point is, for example, a time point at which the current cycle starts.

In the cycle (15), since there is the accumulated speech data accumulated up to the previous cycle, the processing proceeds to step S19, the cycle (15) is ended, the processing returns to step S3, and a cycle (16) is started while continuing the accumulation of the speech data.

The controller 2 performs the control processing in an order of steps S3, S4, S5, S13, S14, S18, and S19 in each of the cycle (16) for a time interval (16) and a cycle (17) for a time interval (17), as in the cycle (15), while continuing the accumulation of the speech data. Here, it is assumed that a time period without utterance in the cycle (16) and the cycle (17) is shorter than the first threshold value. In addition, it is assumed that the time period without utterance becomes longer than the first threshold value in a cycle (18).

After the cycle (17) is ended, the controller 2 starts the cycle (18) for a time interval (18) in step S3, acquires speech data in the time interval (18) in step S4, and combines the acquired speech data with the accumulated speech data that is already stored. In step S5, the controller 2 determines whether a sound pressure of the speech data acquired in step S4 is greater than the predetermined value or not. Since there is almost no change in a speech waveform of the speech data in the time interval (18) in FIG. 4, the controller 2 determines that there is no utterance in step S13, and proceeds to step S14. In step S14, the controller 2 determines whether the state without utterance continues for the first threshold value or longer or not. In the cycle (18), the controller 2 determines that the state without utterance continues for the first threshold value or longer, and proceeds to step S15.

In step S15, the controller 2 determines whether the accumulation time (recording time) of the accumulated speech data stored in the storage 3 is longer than the second threshold value or not. The second threshold value is a threshold value to determine whether there is a sufficient accumulation time to perform the speech recognition with high accuracy by the AI model or not. The second threshold value is, for example, a value from 0.5 seconds to 10.0 seconds, and preferably about 1.0 seconds. The second threshold value is a time period shorter than the third threshold value.

When the accumulation time of the accumulated speech data is longer than the second threshold value, the controller 2 determines that the accumulation time of the accumulated speech data is sufficient to perform the speech recognition, and proceeds to step S10. This allows the controller 2 to end the accumulation of the speech data at a suitable timing immediately after the utterance is interrupted and perform the speech recognition. In addition, since the second threshold value is set to be relatively long, it is possible to make the speech data for which the speech recognition is performed relatively long when the speech recognition is performed using the AI model, and it is possible to perform the speech recognition in consideration of context or the like. Therefore, it is possible to improve the accuracy of transcription of the speech recognition using the AI model. When the accumulation time of the accumulated speech data is shorter than the second threshold value, the controller 2 determines, in step S15, that the accumulation time of the accumulated speech data is insufficient to perform the speech recognition, and proceeds to step S16.

In step S15 of the cycle (18), when the controller 2 determines that the accumulation time of the accumulated speech data is longer than the second threshold value and proceeds to step S10, the controller 2 ends the accumulation of the speech data and performs the speech recognition processing for the accumulated speech data stored in the storage 3 in step S11 using the AI model. Thereafter, the controller 2 ends the cycle (18) in step S12, and starts accumulation of the next speech data in step S2. Speech data to be acquired in step S4 that follows is accumulated as accumulated speech data different from the accumulated speech data previously stored in the storage 3.

When the controller 2 determines that the accumulation time of the accumulated speech data is shorter than the second threshold value in step S15 of the cycle (18) and proceeds to step S16, the controller 2 deletes the speech data acquired in step S4 of the current cycle and ends the cycle (18) in step S17.

In addition, in step S16, when the speech data acquired in step S4 is stored as it is in the storage 3 as the accumulated speech data, the controller 2 deletes the accumulated speech data. When the speech data acquired in step S4 is combined with the accumulated speech data, the controller 2 deletes the speech data acquired in step S4 of the current cycle from the accumulated speech data. This makes it possible to suppress accumulation of speech data without utterance as the accumulated speech data, and to efficiently perform the speech recognition.

When the cycle (18) is ended in step S17, the processing returns to step S3, and a cycle (19) is started while the accumulation of the speech data is continued.

1. A speech recognition method, comprising:
(a) acquiring speech data and accumulating the acquired speech data as accumulated speech data;
(b) determining whether there is an utterance for the acquired speech data or not;
(c) deciding whether to end the accumulation of the speech data or continue the accumulation of the speech data based on a result of the determination as to whether there is an utterance or not that is determined in (b), and an accumulation time of the accumulated speech data; and
(d) performing speech recognition based on the accumulated speech data in a case where the accumulation of the speech data is ended and the accumulated speech data exists.

2. The speech recognition method according to claim 1, wherein
in (c), in a case where it is determined that there is no utterance in (b), a duration of a state without utterance is longer than a first threshold value, and the accumulation time of the accumulated speech data is longer than a second threshold value, the accumulation of the speech data is ended.

3. The speech recognition method according to claim 1, wherein
in (c), in a case where it is determined that there is no utterance in (b), a duration of a state without utterance is longer than a first threshold value, and the accumulation time of the accumulated speech data is shorter than a second threshold value, the accumulation of the speech data is continued.

4. The speech recognition method according to claim 1, wherein
in (c), in a case where it is determined that there is no utterance in (b), and a duration of a state without utterance is shorter than a first threshold value, whether the accumulated speech data accumulated before a predetermined time point exists or not is determined, and in a case where it is determined that the accumulated speech data accumulated before the predetermined time point exists, the accumulation of the speech data is continued.

5. The speech recognition method according to claim 1, wherein
in (c), in a case where it is determined that there is no utterance in (b), and a duration of a state without utterance is shorter than a first threshold value, whether the accumulated speech data accumulated before a predetermined time point exists or not is determined, and in a case where it is determined that the accumulated speech data accumulated before the predetermined time point does not exist, the accumulation of the speech data is ended.

6. The speech recognition method according to claim 5, wherein
in (c), in a case where the accumulated speech data accumulated after the predetermined time point exists, the accumulated speech data accumulated after the predetermined time point is deleted.

7. The speech recognition method according to claim 1, wherein
in (c), in a case where it is determined that there is an utterance in (b) and a duration of a state with the utterance is longer than a third threshold value, the accumulation of the speech data is ended.

8. The speech recognition method according to claim 1, wherein
in (c), in a case where it is determined that there is an utterance in (b) and a duration of a state with the utterance is shorter than a third threshold value, the accumulation of the speech data is continued.

9. The speech recognition method according to claim 1, wherein
a cycle including (a), (b), and (c) is repeatedly performed.

10. A speech recognition apparatus, comprising a controller including a storage, wherein
the controller is provided to accumulate acquired speech data in the storage as accumulated speech data, is provided to decide whether to end the accumulation of the speech data or continue the accumulation of the speech data based on a result of determination as to whether there is an utterance regarding the acquired speech data or not and an accumulation time of the accumulated speech data, and is provided to perform speech recognition based on the accumulated speech data in a case where the accumulation of the speech data is ended and the accumulated speech data exists.
